(19) United States
(12) Patent Application Publication
(10) Pub. No.: US 2011/0235680 A1
(43) Pub. Date: Sep. 29, 2011

(54) SENSOR OF TEMPERATURE

(75) Inventors: Marc Seigneur, Villons les Buissons (FR); Jean Sannier, Juaye Mondaye (FR); Johan Goupil, Ussy (FR); Sebastien Donatien, Perrieres (FR); Dominique Le Bouquin, Herouville St. Clair (FR); Benoit Osmond, Croissanville (FR)

(73) Assignee: SC2N, Creteil (FR)

(21) Appl. No.: 13/072,268

(22) Filed: Mar. 25, 2011

(30) Foreign Application Priority Data
Mar. 26, 2010 (FR) 1001223

(51) Int. Cl. G01K 1/14

(52) U.S. Cl. 374/208; 374/E01.018

(57) ABSTRACT

The invention relates to a motor-vehicle temperature sensor comprising a stop (13) designed to bear against a corresponding bearing surface delimiting a medium, the temperature of which has to be measured, and a means (15) for clamping the stop (13) against the bearing surface.

According to the invention the stop (13) has a peripheral thickness (e) equal to or less than 1.2 mm and the clamping means (15) is made of a material having expansion properties common with the material of the bearing surface and is designed to compensate for the differences in expansion between the stop (13) and the bearing surface.

The present invention relates to a temperature sensor, especially for measuring high temperatures.

The invention applies in particular to temperature sensors suitable for measuring the temperature of gases from motor vehicles, such as the exhaust gases or the gases in the engine compartment.

Such sensors are known for example from documents FR 2 911 958 or FR 2 893 127 in the name of the Applicant.

These sensors comprise a temperature-sensitive element, such as a thermistor, connected on the outside via electrical wires to an electrical/electronic circuit for exploiting a measurement signal.

As an example, such a sensor comprises, at one end, a thermistor housed in a protective casing and two first electrical wires in contact with this thermistor run along the protective casing so as to be accessible to the outside thereof and to provide electrical information representative of the resistance of the thermistor and consequently the measured temperature.

Such a sensor generally includes a stop which is clamped against a bearing surface of a customer interface delimiting a medium, the temperature of which it is desired to know. Thus, the fastening of the sensor to the customer interface and sealing with respect to the outside are ensured.

To avoid differences in expansion between the stop, the clamping means and the customer interface, and therefore sealing defects, materials of the same type, and therefore the same expansion coefficient with respect to the customer interface, the stop and the clamping means, are used.

It is therefore necessary each time to adapt the stop and the clamping means according to the customer interface on which the sensor has to be fastened. The sensor therefore becomes a specific part for each application, thereby incurring high costs.

The objective of the invention is therefore to alleviate these drawbacks of the prior art by providing a lower-cost sensor, while still ensuring the required sealing.

For this purpose, the subject of the invention is a motor-vehicle temperature sensor comprising a stop designed to bear against a corresponding bearing surface delimiting a medium, the temperature of which has to be measured, and a means for clamping the stop against the bearing surface, characterized in that the stop has a peripheral thickness equal to or less than 1.2 mm and in that the clamping means is made of a material having expansion properties common with the material of the bearing surface and is designed to compensate for the differences in expansion between the stop and the bearing surface.

The term “peripheral thickness” is understood to mean the axial thickness around the external perimeter of the stop.

Thus, a standard stop allowing the manufacturing costs to be reduced is obtained, and only the clamping means is adapted according to the material of the customer interface so as to ensure sealing. Specifically, with a peripheral thickness as defined above, the expansion of the stop during use of the high-temperature sensor is not a key factor in sealing the sensor.

Said sensor may furthermore comprise one or more of the following features, taken separately or in combination:
the stop is made of a high-temperature-resistant material chosen independently of the material of said bearing surface;
the stop is made of an alloy of chromium, nickel and iron;
the stop is made of austenitic stainless steel;
the stop is made of ferritic stainless steel;
the stop is produced according to one of the following processes: lathe turning, cold stamping, drawing;
the clamping means is made of ferritic steel;
the clamping means is made of austenitic steel;
the clamping means is a locking screw; and
the locking screw has a length of around 2 mm.

Other features and advantages of the invention will become apparent from the following description, given by way of example but without any limiting character, in conjunction with the appended drawings in which:

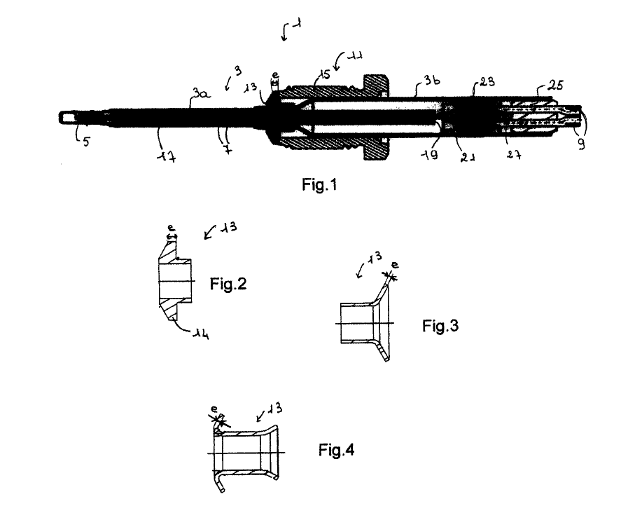

FIG. 1 shows a longitudinal sectional view of a sensor according to the invention;

FIG. 2 is a longitudinal sectional view of a stop of the sensor of FIG. 1;

FIG. 3 is a longitudinal sectional view of an alternative embodiment of the stop of the sensor of FIG. 1; and

FIG. 4 is a longitudinal sectional view of another alternative variant of the stop of the sensor of FIG. 1.

In these figures the substantially identical elements bear the same reference numbers.

FIG. 1 shows a temperature sensor 1 comprising a protective casing 3 of tubular general shape housing a temperature-sensitive element, such as a thermistor 5, and two first electrical wires 7 connected to two second electrical wires 9 serving to provide electrical connection with an electrical/electronic circuit of a processing unit in order to send the temperature signal delivered by the thermistor 5 to the processing unit.

The thermistor 5 is a passive component made of a semiconductor material, the resistance of which varies according to the temperature and may be of the NTC (negative temperature coefficient) type when the resistance decreases as the temperature rises or of the PTC (positive temperature coefficient) type in the opposite case.

The protective casing 3 is made of a high-temperature-resistant metallic material, such as an alloy of chromium, nickel and iron of the Inconel® trademark 601 (registered trade mark) type or else a refractory steel.

As shown in FIG. 1, the casing 3 may comprise a first portion 3a at the thermistor 5 and a second portion 3b, of larger diameter than the first portion 3a, at the zone for connecting the first 7 and second 9 electrical wires.

This protective casing 3 may include a system 11 for fastening onto a wall (not shown) of a customer interface delimiting a medium, the temperature of which it is desired to know, such as the cylinder block of an engine. To do this, the fastening system 11 may include an external stop 13 and a clamping means, such as a screw 15, for clamping the stop 13 against a complementary bearing surface of the wall delimiting the medium to be measured.

To ensure sealing when the sensor 1 is fastened to the wall delimiting the medium in question, the stop 13 and the screw 15 in this example are defined so that only the screw 15 is adapted according to the material of the bearing surface.

To do this, a stop 13, better visible in FIGS. 2 to 4, of smaller axial peripheral thickness e compared with the prior art, i.e. less than or equal to 1.2 mm, for example between 0.5 and 1 mm, and a screw 15 (FIG. 1) of longer length, for example around 2 mm, than the prior art are provided.

The stop 13 may be produced by lathe turning or by cold stamping. The result is shown in FIGS. 1 and 2. This stop 13 has for example a thickness e of around 1 mm. It is clear from FIG. 2 that the axial peripheral thickness e is the thickness around the external peripheral perimeter 14 of the stop 13.

In the examples shown in FIGS. 3 and 4, the stop 13 is obtained by drawing and has a thickness e of around 0.5 mm.

The representations in FIGS. 2 to 4 are schematic and not drawn to scale.

As a consequence, the material of the stop 13 is of course a high-temperature-resistant material, but one chosen independently of the material of the bearing surface, thereby making it possible to standardize the sensor 1 and therefore reducing the manufacturing costs thereof. For example, mention may be made of high-temperature steels or alloys, such as austenitic or ferritic stainless steel, or an alloy of chromium, nickel and iron of the Inconel® 601 (registered trade mark) type.

The material of the screw 15 itself is chosen each time to have the same nature as the bearing surface of the customer interface defining the medium to be measured. More precisely, the material of the screw 15 has an expansion coefficient substantially equal to that of the material of the bearing surface. As an example when the bearing surface is made of ferritic steel or cast iron, a ferritic steel screw 15 is chosen, and when the bearing surface is made of austenitic steel an austenitic steel screw 15 is chosen.

The smallest peripheral thickness of the stop 13, the length of the screw 15 and the expansion coefficient of the material of the screw 15 therefore make it possible to compensate for any differences in expansion between the stop 13 and the wall of the customer interface.

Moreover, again referring to FIG. 1, the first electrical wires 7 are held in place in an insulating sheath 17 having an associated passage 19 for each first electrical wire 7 so that they are insulated from each other and held in place by the insulating sheath 17.

The insulating sheath 17 is of elongate general shape, the longitudinal direction of which corresponds to the direction of the first electrical wires 7. This sheath 17 comprises an envelope of cylindrical general shape so as to be able to conform to the wall of tubular shape, for example the wall of the first portion 3a, of the protective casing 3 and to be held in place thereby.

To give an example, the sheath 17 is made of an electrically insulating heat-resistant ceramic.

In addition, the first electrical wires 7 each have one end connected to the thermistor 5 and an opposite end connected to a second electrical wire 9. The first electrical wires 7 may be connected by means of an electrical connection part 21, for example in the form of a lug, to the larger-diameter second electrical wires 9 of lower-performance materials so as to reduce the costs.

The casing 3 may furthermore include an electrical insulator 23 at the electrical connection of the first 7 and second 9 electrical wires, a seal 25 partially surrounding the two second electrical wires 9 at the opposite end of the sensor 1 with respect to the thermistor 5, and optionally a spacer 27, for example formed from a single part with the electrical insulator 23, this spacer being interposed between the electrical insulator 23 and the seal 25.

The electrical insulator 23 also has a cylindrical general shape so as to be able to conform to the wall of tubular shape, for example that of the second portion 3b, of the protective casing 3 and to be held in place thereby. To give an example, the electrical insulator 11 is an electrically insulating heat-resistant ceramic.

This electrical insulator 23 has two housings for accommodating the connection lugs 21 and therefore enables the two connection lugs 21 to be electrically isolated from each other and also with respect to the casing 3. In addition, this insulator 11 limits the translational movement of the connection lugs 21 so as to prevent a tensile force on the second electrical wires 9 causing the internal components of the sensor 1 to be ejected or damaged.

The seal 25, for example made of an elastomer, also has a cylindrical general shape so as to be able to conform to the wall of tubular shape, for example that of the second portion 3b, of the protective casing 3 and to be held in place thereby. It also has two passages 35 for the second electrical wires 9.

Thus, a sensor 1 is obtained of which the stop 13 of the system 11, for fastening to a wall of a customer interface defining a medium to be measured, is standard irrespective of the material of the customer interface and only the screw 15 of which has to be adapted according to the customer interface in order to guarantee sealing.

1. A motor-vehicle temperature sensor comprising:
a stop configured to bear against a corresponding bearing surface delimiting a medium, wherein the temperature of medium is measured; and
a means for clamping the stop against the bearing surface,
wherein the stop comprises a peripheral thickness equal to or less than 1.2 mm, and
wherein the clamping means is made of a material having expansion properties common with a material of the bearing surface and is configured to compensate for differences in expansion between the stop and the bearing surface.

2. The sensor according to claim 1, wherein the stop is made of a high-temperature-resistant material chosen independently of the material of said bearing surface.

3. The sensor according to claim 2, wherein the stop is made of an alloy of chromium, nickel, and iron.

4. The sensor according to claim 2, wherein the stop is made of austenitic stainless steel.

5. The sensor according to claim 2, wherein the stop is made of ferritic stainless steel.

6. The sensor according to claim 1, wherein the stop is produced according to one selected from a group consisting of the following processes: lathe turning, cold stamping, and drawing.

7. The sensor according to claim 1, wherein the sensor is fastened onto the bearing surface made of ferritic steel or cast iron, and wherein the clamping means is made of ferritic steel.

8. The sensor according to claim 1, wherein the sensor is fastened onto the bearing surface made of ferritic steel or cast iron, and wherein the clamping means is made of austenitic steel.

9. The sensor according to claim 1, wherein the clamping means is a locking screw.

10. The sensor according to claim 9, wherein the locking screw has a length of 2 mm.
